(19) United States
(12) Patent Application Publication
(10) Pub. No.: US 2025/0249758 A1
(43) Pub. Date: Aug. 7, 2025

(54) END OF BATTERY STATE OF CHARGE (SOC) VEHICLE SYSTEM OPERATION

(71) Applicant: Cummins Inc., Columbus, IN (US)

(72) Inventor: John P. Kresse, III, Martinsville, IN (US)

(21) Appl. No.: 19/095,417

(22) Filed: Mar. 31, 2025

Related U.S. Application Data
(63) Continuation of application No. 17/276,701, filed on Mar. 16, 2021, now Pat. No. 12,263,737.
(60) Provisional application No. 62/779,893, filed on Dec. 14, 2018.

(51) Int. Cl. B60L 15/20; B60H 1/00; B60K 6/28; B60L 58/13; G07C 5/08

(52) U.S. Cl. CPC B60L 15/2045; B60K 6/28; B60L 58/13; B60H 1/00735; B60H 1/00878; B60L 2210/10; B60L 2240/12; B60L 2240/14; B60L 2240/486; B60L 2240/54; B60L 2240/60; B60L 2250/10; B60L 2250/16; B60L 2260/54; B60Y 2200/91; B60Y 2200/92; G07C 5/0825; G07C 5/0833

(57) ABSTRACT

The present disclosure provides a multi-stage method to extend the range of a vehicle. The method includes taking progressive actions on a vehicle as the state of charge (SOC) drops below defined levels. The method may include monitoring the SOC of the vehicle in relation to a SOC threshold or monitoring the SOC of the vehicle in relation to the distance remaining to a predetermined destination.

### CROSS-REFERENCE TO RELATED APPLICATIONS

The present application is a continuation of and claims priority to U.S. patent application Ser. No. 17/276,701, filed Mar. 16, 2021, with is a national stage filing of International Application No. PCT/US2019/066195, filed Dec. 13, 2019, which claims priority of U.S. Provisional Application No. 62/779,893, filed Dec. 14, 2018, the disclosures of which being expressly incorporated herein by reference.

### TECHNICAL FIELD OF THE PRESENT DISCLOSURE

The present invention generally relates to a method for extending the range of a vehicle, and more particularly, to a method for extending the range of a vehicle as the state-of-charge (“SOC”) of the vehicle drops below pre-defined levels.

### BACKGROUND OF THE PRESENT DISCLOSURE

Batteries of electric vehicles may be prematurely aged or damaged if the vehicle is operated when the SOC is below a certain threshold. Typically, a vehicle operator uses SOC information similarly to how an operator uses fuel information provided by a fuel gauge on a conventional vehicle. As the SOC decreases, the operator judges (often based on prior experience) whether the vehicle can achieve its mission, and at some point, the operator ends the mission and charges the vehicle.

### SUMMARY OF THE PRESENT DISCLOSURE

The present disclosure provides a multi-stage method to extend the range of a vehicle. The method includes taking progressive actions on a vehicle as the state of charge (SOC) drops below defined levels. The method may include monitoring the SOC of the vehicle in relation to a SOC threshold or monitoring the SOC of the vehicle in relation to the distance remaining to a predetermined destination.

According to an embodiment of the present disclosure, a method for notifying a driver of a state of charge (“SOC”) of an electrical energy storage device of a vehicle is disclosed. The method comprises: monitoring the SOC; determining whether the SOC is less than a first SOC threshold; determining whether the SOC is less than a second SOC threshold, the first SOC threshold being greater than the second SOC threshold; and responding to the SOC being less than the first SOC threshold and greater than the second SOC threshold by activating a SOC conservation system, the SOC conservation system activating a first set of SOC conservation steps including at least one of: flashing an indicator light at a first rate, limiting a speed of vehicle to a first vehicle speed reducing a SOC power limit, managing vehicle acceleration, disabling an air conditioning compressor, decreasing a cooling rate, modifying a shift schedule, and reducing a rate of maximum allowable DC-DC converter power; and responding to the SOC being less than the first SOC threshold and the second SOC threshold, by causing the SOC conservation system to activate a second set of SOC conservation steps including at least one of: flashing an indicator light at a second rate that is greater than the first rate; limiting the speed of vehicle speed to a second speed that is less than the first speed, reducing an SOC power limit, disabling cooling loops thereby deactivating cooling, and activating vehicle warning flashers.

The method may further comprise determining whether the SOC is less than a third SOC threshold, the second SOC threshold being greater than the third SOC threshold; responding to the SOC being less than the first SOC threshold and the second SOC threshold and greater than the third SOC threshold by causing the SOC conservation system to activate a second set of SOC conservation steps including at least one of: flashing an indicator light at a second rate that is greater than the first rate; limiting the speed of vehicle speed to a second speed that is less than the first speed, reducing an SOC power limit, disabling cooling loops thereby deactivating cooling, and activating vehicle warning flashers; and responding to the SOC being less than the first SOC threshold, the second SOC threshold, and the third SOC threshold by causing the SOC conservation system to activate a third set of SOC conservation steps.

The thirds set of SOC conservation steps may further include activating an internal combustion engine. The vehicle may be a hybrid electric vehicle, wherein the third set of SOC conservation steps further includes activating an internal combustion engine of the vehicle. When the SOC is greater than the first SOC threshold, the SOC conservation system may be deactivated. The vehicle may be a battery electric vehicle. The vehicle may be a range extended electric vehicle.

According to another embodiment of the present disclosure, a method of notifying a driver of a vehicle of a state of charge (“SOC”) of an electrical energy storage device of the vehicle in relation to a destination is disclosed. The method comprises: receiving destination information; calculating a route and a distance in response to receiving the destination information; determining whether a current SOC of the electrical energy storage device is sufficient to reach the destination; responding to the current SOC being insufficient to reach the destination by activating a set of SOC conservation steps; and monitoring the SOC of the electrical energy storage device until the vehicle reaches the destination.

The set of SOC conservation steps may include at least one of: flashing an indicator light, limiting speed of vehicle, reducing an SOC power limit, limiting vehicle acceleration, disabling an air conditioning compressor, decreasing cooling rate, modifying shift schedule, reducing a rate of maximum allowable DC-DC converter power, deactivating cooling, activate vehicle warning flashers, activating the indicator light, providing a verbal indication to the driver of the vehicle, and shutting down a high voltage system of the vehicle. The set of SOC conservation steps may include activating an internal combustion engine of the vehicle. The vehicle may be a battery electric vehicle. The vehicle may be a range extended electric vehicle. The vehicle may be a hybrid electric vehicle, wherein the set of SOC conservation steps further includes activating an internal combustion engine of the vehicle. The method may further comprise responding to the current SOC being sufficient to reach the destination by monitoring the SOC of the electrical storage device until the vehicle reaches the destination.

According to yet another embodiment of the present disclosure, a method for notifying a driver of a state of charge (“SOC”) of an electrical energy storage device of a vehicle is disclosed. The method comprising: monitoring the SOC; determining whether the SOC is less than a first SOC threshold; determining whether the SOC is less than a second SOC threshold, the first SOC threshold being greater than the second SOC threshold and the third SOC threshold; and responding to the SOC being is less than the first SOC threshold and greater than the second SOC threshold by activating a SOC conservation system, the SOC conservation system activating a first set of SOC conservation steps that conserve a first amount of energy; and responding to the SOC being less than the first SOC threshold and the second SOC threshold by causing the SOC conservation system to activate a second set of SOC conservation steps that conserve a second amount of energy that is greater than the first amount of energy.

Additional features and advantages of the present disclosure will become apparent to those skilled in the art upon consideration of the following detailed description of the illustrative embodiments exemplifying the disclosure as presently perceived.

### BRIEF DESCRIPTION OF THE DRAWINGS

The detailed description of the drawings particularly refers to the accompanying figures in which:

FIG. 1 is a schematic block diagram of a hybrid vehicle system;

FIG. 2 is a block diagram of a control system for a state of charge (SOC) conservation system of the vehicle of FIG. 1;

FIG. 3 is a flowchart illustrating a method for monitoring an SOC of a vehicle and extending vehicle range based on the SOC in accordance with the present disclosure; and

FIG. 4 is a flowchart illustrating a method for monitoring the SOC of a vehicle based on a distance to a destination in accordance with the present disclosure.

Corresponding reference characters indicate corresponding parts throughout the several views. Although the drawings represent embodiments of various features and components according to the present disclosure, the drawings are not necessarily to scale and certain features may be exaggerated in order to better illustrate and explain the present disclosure. The exemplification set out herein illustrates an embodiment of the invention, and such an exemplification is not to be construed as limiting the scope of the invention in any manner.

### DETAILED DESCRIPTION OF THE DRAWINGS

The present disclosure provides a multi-stage method to extend the range of a vehicle. The method includes taking progressive actions on a vehicle as the state of charge (SOC) drops below defined levels. The method may include monitoring the SOC of the vehicle in relation to a SOC threshold or monitoring the SOC of the vehicle in relation to the distance remaining to a predetermined destination.

As discussed further herein, the present disclosure provides a method for extending the range of a vehicle by monitoring a vehicle battery's SOC. The present disclosure discusses embodiments for a battery electric vehicle (BEV) and a range extended electric vehicle (REEV), also known as a series hybrid. However, it is within the scope of the present disclosure that the method described herein can be applied to other types of all electric and/or hybrid electric vehicles.

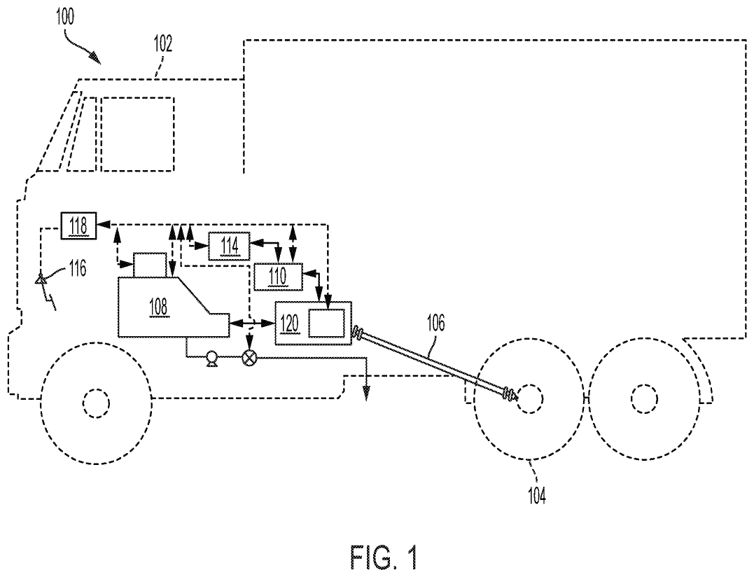

Referring first to FIG. 1, an exemplary system 100 includes a vehicle 102 that includes cargo carrying capability, although system 100 is not limited to cargo carrying vehicles. For example system 100 may also be used in transit vehicles, passenger vehicles, and other vehicles. System 100 further includes a hybrid power train having an internal combustion engine 108 and an electric device 110 selectively coupled to a drive shaft 106. The engine 108 may be any type of internal combustion engine known in the art. In some applications, the internal combustion engine 108 may be a diesel engine. In the example of FIG. 1, the engine 108 and the electric device 110 are coupled to the driveshaft 106 through a transmission 120 having a power splitter (not shown). However, any hybrid configuration known in the art, including at least series, parallel, and series-parallel, is contemplated herein.

The system 100 further includes an electric generator that is selectively coupled to the drive shaft 106 and further coupled to an electrical energy storage device 114. The electric generator in FIG. 1 is included with the electric device 110 as an electric motor/generator. However, the electric generator may be a separate device. The electrical energy storage device 114 is electrically connected to the generator 110 to store electricity generated by the generator 110. The electrical energy storage device 114 can be a battery such as a lithium ion battery, a lead-acid battery, a nickel metal hydride battery, or any other device capable of storing electrical energy. In certain embodiments, energy may be stored non-electrically, for example in a high performance fly wheel, in a compressed air tank, and/or through deflection of a high capacity spring. Where the energy is stored electrically, any electrical energy storage device 114 is contemplated herein, including a hyper-capacitor and/or an ultra-capacitor.

In certain embodiments, the system 100 includes the drive shaft 106 mechanically coupling the hybrid power train to a vehicle drive wheel 104. The system 100 may include any type of load other than or in addition to the drive wheel 104, for example any load that includes stored kinetic energy that may intermittently be slowed by any braking device included in the hybrid power train.

The system 100 further includes a deceleration request device 116 that provides a deceleration request value. An exemplary deceleration request device comprises a throttle pedal position sensor. However, any device understood in the art to provide a deceleration request value, or a value that can be correlated to a present negative torque request for the hybrid power train is contemplated herein.

The system 100 further includes a controller 118 having modules structured to functionally execute operations for managing operation of the engine 108. In certain embodiments, the controller 118 forms a portion of a processing subsystem including one or more computing devices having memory, processing, and communication hardware. The controller 118 may be a single device or a distributed device, and the functions of the controller 118 may be performed by hardware or software. In certain embodiments, the controller 118 includes one or more modules structured to functionally execute the operations of the controller 118. In certain embodiments, the controller 118 may alter the operation of the engine 108 in response to an SOC of the energy storage device 114.

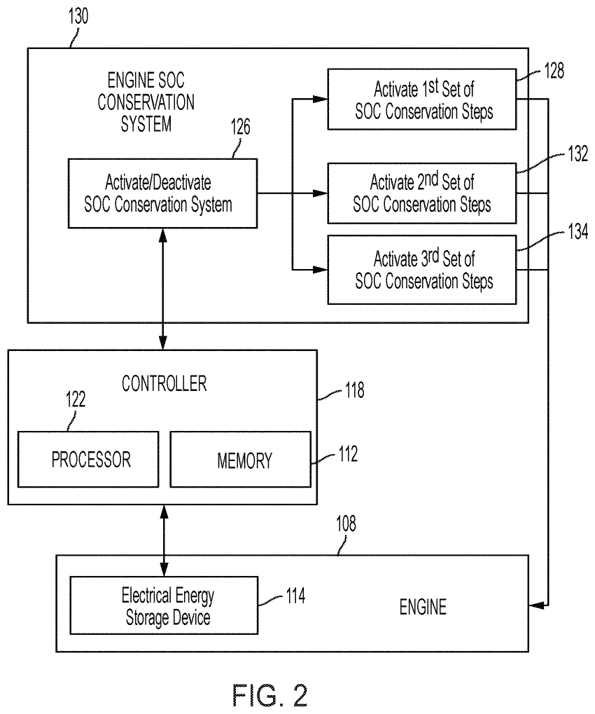

Referring to FIG. 2, an exemplary control system for the engine 108 is shown. In particular, FIG. 2 shows the functional relationships between the controller 118 and other units of the system 100 (e.g., an engine SOC conservation system 130). The controller 118 includes a processor 122 and a non-transitory memory 112. The processor 122 executes the instructions stored in the memory 112, and the non-transitory memory 112 stores the aforementioned instructions regarding operation of the controller 118 and the threshold values for the engine SOC conservation system 130 as discussed further herein.

The controller 118 is in electrical communication with the electrical energy storage device 114 such that the controller 118 monitors the SOC of the electrical energy storage device 114 and periodically measures the SOC of the electrical energy storage device 114. Upon receiving the SOC of the electrical energy storage device 114, the processor 122 compares the SOC with threshold values stored in the memory 112. As discussed further herein, the threshold values include a plurality of values that each correspond with a set of SOC conservation steps (e.g., a first set of SOC conservation steps 128, a second set of SOC conservation steps 132, and a third set of SOC conservation steps 134).

Based on the comparison of the SOC of the electrical energy storage device 114 with the threshold values, the processor 122 of the controller 118 toggles the operational state of the engine SOC conservation system 130. If the SOC of the electrical energy storage device 114 is less than at least one of the threshold values stored in the memory 112, then the processor 112 activates the engine SOC conservation system 130 by toggling an activation switch 126 (e.g., a power switch) into an active state. The processor 122 of controller 118 then proceeds to activate one of the corresponding sets of the conservation steps 128, 132, 134 based on the measured SOC of the electrical energy storage device 114 in relation to the threshold values. These SOC conservation steps are then applied to the engine 108 and/or the system 100 (FIG. 1) as discussed further herein. Conversely, if the SOC of the electrical energy storage device 114 is greater than the threshold values stored in memory 112, then the processor 112 deactivates the engine SOC conservation system 130 by toggling an activation switch 126 (e.g., a power switch) into an inactive state.

During and after execution of the aforementioned procedure, the controller 118 monitors the SOC of the electrical energy storage device 114. After a predetermined time period, the controller 118 receives an updated SOC value of the SOC of the electrical energy storage device 114 and the aforementioned procedure is repeated.

The description herein including modules emphasizes the structural independence of the aspects of the controller 118 and illustrates one grouping of operations and responsibilities of the controller 118. Other groupings that execute similar overall operations are understood within the scope of the present application. Modules may be implemented in hardware and/or software on computer readable medium, and modules may be distributed across various hardware or software components. Additionally, the controller 118 need not include all of the modules discussed herein.

Certain operations described herein include evaluating one or more parameters. Evaluating, as utilized herein, includes, but is not limited to, receiving values by any method known in the art, including at least receiving values from a datalink or network communication, receiving an electronic signal (e.g., a voltage, frequency, current, or PWM signal) indicative of the value, receiving a software parameter indicative of the value, reading the value from a memory location on a computer readable medium, receiving the value as a run-time parameter by any means known in the art, and/or by receiving a value by which the interpreted parameter can be calculated, and/or by referencing a default value that is interpreted to be the parameter value.

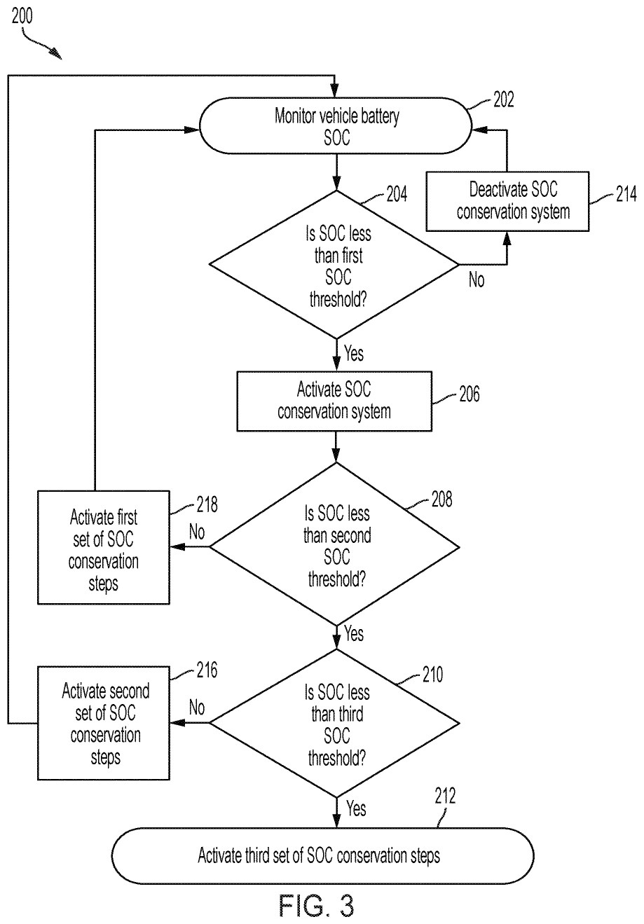

Referring now to FIGS. 2 and 3, a method 200 is provided to monitor the SOC of the electrical energy storage device 114 and to alter operating conditions of the engine 108 depending on the SOC of the electrical energy storage device 114. The method 200 can be executed by the controller 118 (FIG. 1) or by an electronic control module (ECM, not shown). The method 200 begins at step 202 where the controller 118 monitors the SOC of the electrical energy storage device 114 during operation of the vehicle. Periodically, the controller 118 compares the SOC of the electrical energy storage device 114 to a predetermined first SOC threshold as indicated by block 204. In one embodiment, the first SOC threshold is an SOC value of between 10% to 20% of full capacity of the energy storage device 114. However, it is contemplated that in alternate embodiments, other SOC value ranges may be used. As shown, if the SOC of the energy storage device 114 is greater than the first SOC threshold, then the controller 118 deactivates the SOC conservation system 130 (if previously activated) at block 214 and then continues to monitor the SOC of the energy storage device 114 as indicated by block 202. The SOC conservation system 130 includes instructions for operating various remedial measures carried out by the controller 118 when the electrical energy storage device 114 SOC is less than the predetermined thresholds described further herein and as exemplified in functional blocks 204, 208, 210, 212, 216, and 218.

If at step 204, the SOC of the electrical energy storage device 114 is less than the first SOC threshold, the controller 118 activates the SOC conservation system 130 of the vehicle at block 206. After the SOC conservation system 130 is activated, the controller 118 compares the SOC of the electrical energy storage device 114 to a second SOC threshold at block 208. In one embodiment, the second SOC threshold includes a predetermined hysteresis value. It is contemplated that in alternate embodiments, other SOC thresholds (e.g., first SOC threshold, third SOC threshold, etc.) can include the hysteresis addition when comparing the SOC of the electrical energy storage device 114 to the SOC thresholds. As shown, if the SOC of the electrical energy storage device 114 is greater than the second SOC threshold, then the controller 118 activates a first set of SOC conservation steps 128 as discussed further herein. In one embodiment, the first set of SOC conservation steps 128 includes at least one of the following: flashing an indicator light (e.g., a low SOC lamp) at a slow rate (e.g., 1 flash per 3 seconds); ramping, over a calibratable time (e.g., 2 minutes), a road speed governor to a calibratable top speed value (e.g., 40 miles per hour (mph)); ramping, over a calibratable time (e.g., 2 minutes), a traction motor maximum power limit down to a calibratable (default 30%) derate (i.e., reduce maximum traction motor power by 30% such that the operator can still complete the mission yet the derate is intrusive enough such that the operator knows battery SOC is getting low); activating vehicle acceleration management to control/limit acceleration rate; disabling an air conditioning (A/C) compressor, if so equipped; increasing each cooling loop reference temperature (except battery cooling circuit) by a predetermined amount (e.g., 10° C.); modifying a shift schedule for best efficiency including inhibiting top gear operation, if needed; and reducing the rate of maximum allowable DC-DC converter power to a predetermined amount (e.g., 50%). After the first set of SOC conservation steps 128 are activated, the method 200 returns to block 202 where the controller 118 monitors the SOC of the electrical energy storage device 114. In one embodiment, the first SOC conservation steps 128 occur simultaneously. However, it is contemplated that in alternate embodiments, the first SOC conservation steps 128 occur in a predetermined, prioritized order based on the priority of the action.

Returning to block 208, if the SOC of the electrical energy storage device 114 is less than the second SOC threshold, then at step 210, the controller 118 compares the SOC of the electrical energy storage device 114 to a third SOC threshold. As shown, if the SOC of the electrical energy storage device 114 is greater than the third SOC threshold, then the controller 118 activates a second set of SOC conservation steps 132 at block 216. In one embodiment, the second set of SOC conservation steps 132 includes at least one of the following: flashing an indicator light (e.g., a low SOC lamp) at a faster rate (e.g., 1 flash per second); ramping, over a calibratable time (e.g., 2 minutes), a road speed governor to a calibratable value (e.g., 25 mph maximum speed); ramping, over a calibratable time (e.g., 2 minutes), an additional reduction in traction motor maximum power limit to a calibratable derate (e.g., 50%); if so equipped with on/off cooling loop control, disabling cooling loops (except battery cooling circuit); and automatically activating vehicle warning flashers. After the second set of SOC conservation steps 132 are activated, the method 200 returns to block 202 where the controller 118 monitors the SOC of the electrical energy storage device 114. In one embodiment, the second SOC conservation steps 132 occur simultaneously. However, it is contemplated that in alternate embodiments, the second SOC conservation steps 132 occur in a predetermined, prioritized order based on the priority of the action.

Returning to step 210, if the electrical energy storage device 114 SOC is less than the third SOC threshold 132, then a third set of SOC conservation steps 134 are activated at step 212. In one embodiment, the third set of SOC conservation steps 134 includes at least one of the following: providing/activating a solid indicator light (i.e., no flashing-solid “Low SOC” lamp); automatically playing a verbal message to the driver (e.g., a message to the driver or a song indicating that the SOC of electrical energy storage device 114 is low); and shutting down the high voltage system (through normal high voltage shutdown logic) of the vehicle. After the third set of SOC conservation steps 134 are activated, the controller 118 monitors the SOC of the electrical energy storage device 114 as the method 200 returns to block 202. In one embodiment, the third SOC conservation steps 134 occur simultaneously. However, it is contemplated that in alternate embodiments, the third SOC conservation steps 134 occur in a predetermined, prioritized order based on the priority of the action.

The method 200, as described herein, discloses three predetermined SOC thresholds. However, it is within the scope of the present disclosure that greater than or fewer than three SOC thresholds may be applied. In addition, in alternate embodiments, the method 200 can use distance thresholds in place of the SOC thresholds as discussed further herein.

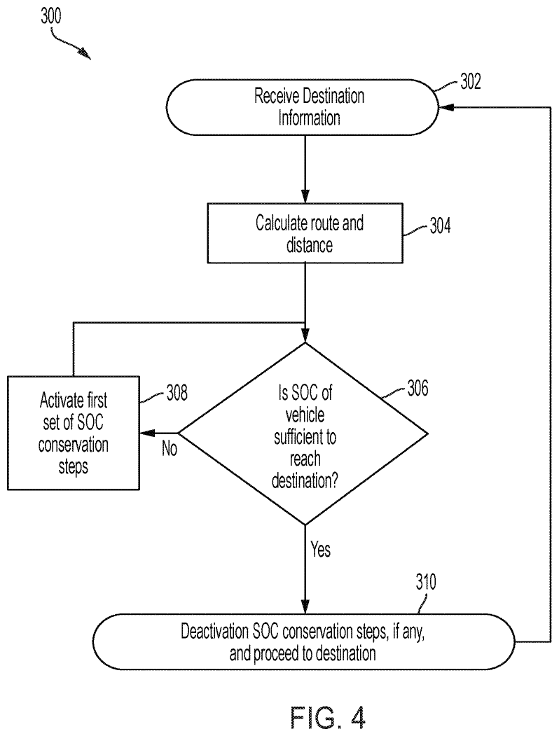

Referring now to FIG. 4, an alternate method 300 of monitoring the electrical energy storage device 114 SOC is provided. As discussed further herein, the method 300 receives the destination to which the vehicle is travelling and determines whether the vehicle under its current operating conditions and current SOC can reach the destination. If not, the method activates a series of SOC conservation steps to increase the range of the vehicle.

The method 300 can be executed by the controller 118 or by an electronic control module (ECM, not shown). As shown in FIG. 3, the method 300 begins at step 302 where the controller 118 receives destination information from the ECM. In another embodiment, the controller 118 receives destination information from an external GPS of a mobile device. Destination information can be relayed from an onboard GPS-based navigation system or, via a cellular network, or from a fleet manager's routing system. Alternatively, all destination calculations can be performed in a cloud-based application with the range comparison determination discussed herein being sent to the controller 118 instead of having the controller 118 perform the calculations. Once the destination information is received, the method 300 proceeds to block 204 where the route and distance are calculated. From this calculation, the controller 118 determines, at block 306, whether the SOC of the electrical energy storage device 114 is sufficient to reach the destination. If the SOC of the electrical energy storage device 114 is insufficient to reach the destination, then the controller 118 activates a set of SOC conservation steps at block 308. The set of SOC conservation steps include at least one of: flashing an indicator light (e.g., a low SOC lamp); ramping, over a calibratable time (e.g., 2 minutes), a road speed governor to a calibratable a top speed value (e.g., 40 miles per hour (mph)); ramping, over a calibratable time (e.g., 2 minutes), a reduction in traction motor power limit to a calibratable (default 30%) derate; activating a vehicle acceleration management to control/limit acceleration rate; disabling an air conditioning (A/C) compressor, if so equipped; increasing each cooling loop reference temperature (except battery cooling circuit) by a predetermined amount (e.g., 10° C.); modifying a shift schedule for best efficiency including inhibiting of top gear operation, if needed; reducing the rate of maximum allowable DC-DC converter power to a predetermined amount (e.g., 50%); if so equipped with on/off cooling loop control, disabling cooling loops (except battery cooling circuit); providing a solid indicator light (i.e., no flashing-solid “Low SOC” lamp); automatically playing a verbal message to the driver (e.g., a message to the driver or a song indicating that the electrical energy storage device 114 SOC is low); and shutting down the high voltage system (through normal high voltage shutdown logic) of the vehicle. After the set of SOC conservation steps are activated, the controller 118 monitors the SOC of the electrical energy storage device 114 at block 306 to determine whether the SOC is sufficient to reach the destination.

Returning to block 306, if the SOC of the electrical energy storage device 114 is sufficient to reach the destination, then the controller 118 deactivates any SOC conservation steps that are active, and the vehicle is permitted to proceed to the inputted destination at block 302. The method 300 then periodically returns to block 302 where the controller 118 monitors the vehicle SOC in relation to the destination until the vehicle reaches the destination.

In certain embodiments, the controller 118 can form a portion of a processing subsystem including one or more computing devices having memory, processing, and communication hardware. The controller 118 can be a single device or a distributed device, and functions of the controller 118 can be performed by hardware and/or as computer instructions on a non-transient computer readable storage medium, such as the non-transitory memory 112.

In certain embodiments, the controller 118 includes one or more interpreters, determiners, evaluators, regulators, and/or processors 122 that functionally execute the operations of the controller 118. The description herein including interpreters, determiners, evaluators, regulators, and/or processors emphasizes the structural independence of certain aspects of the controller 118 and illustrates one grouping of operations and responsibilities of the controller 118. Other groupings that execute similar overall operations are understood to be within the scope of the present disclosure. Interpreters, determiners, evaluators, regulators, and processors can be implemented in hardware and/or as computer instructions on a non-transient computer readable storage medium and can be distributed across various hardware or computer-based components.

Example and non-limiting implementation elements that functionally execute the operations of the controller 118 include sensors providing any value determined herein, sensors providing any value that is a precursor to a value determined herein, datalink and/or network hardware including communication chips, oscillating crystals, communication links, cables, twisted pair wiring, coaxial wiring, shielded wiring, transmitters, receivers, and/or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), and/or digital control elements.

Certain operations described herein include operations to interpret and/or to determine one or more parameters or data structures. Interpreting or determining, as utilized herein, includes receiving values by any method known in the art, including at least receiving values from a datalink or network communication, receiving an electronic signal (e.g. a voltage, frequency, current, or PWM signal) indicative of the value, receiving a computer generated parameter indicative of the value, reading the value from a memory location on a non-transient computer readable storage medium, receiving the value as a run-time parameter by any means known in the art, and/or by receiving a value by which the interpreted parameter can be calculated, and/or by referencing a default value that is interpreted to be the parameter value.

While the invention has been described by reference to various specific embodiments it should be understood that numerous changes may be made within the spirit and scope of the inventive concepts described, accordingly, it is intended that the invention not be limited to the described embodiments but will have full scope defined by the language of the following claims.

What is claimed is:

1. A method for extending a range of a vehicle, comprising: acquiring vehicle information relative to a multistage conservation step criteria, wherein the multistage conservation step criteria includes at least one of a current state of charge (SOC) of an energy storage device and current operating conditions of the vehicle; determining whether the vehicle satisfies the multistage conservation step criteria based on an ability of the vehicle to complete a mission; and executing a sequence of conservation steps in stages, wherein each stage progressively restricts vehicle performance in response to the determination.

2. The method of claim 1, wherein the vehicle information includes at least one of propulsion power demand, auxiliary system power usage, vehicle speed, and ambient conditions.

3. The method of claim 1, wherein the conservation steps include derating at least one of acceleration, top speed, and climate control system operation.

4. The method of claim 1, wherein the multistage conservation step criteria includes a plurality of SOC thresholds, each corresponding to a different conservation stage.

5. The method of claim 1, wherein a controller logs each conservation step and associated vehicle condition for later analysis.

6. The method of claim 1, further comprising notifying a vehicle occupant of the current conservation stage and upcoming stages.

7. A method for controlling energy usage in a vehicle, comprising: acquiring SOC data and operating condition data of the vehicle; evaluating the SOC data and operating condition data against a multistage conservation step criteria, the conservation step criteria comprising a determination of whether the vehicle can complete a mission prior to reaching a destination or depleting the SOC below a minimum reserve; and initiating a multistage sequence of performance-limiting actions, each stage corresponding to a worsening state of the vehicle's ability to complete the mission.

8. The method of claim 7, wherein each performance-limiting action is more restrictive than a preceding action.

9. The method of claim 7, wherein the mission includes a user-defined destination received via a navigation system.

10. The method of claim 7, wherein the conservation step criteria includes a minimum SOC reserve required to complete the mission.

11. The method of claim 7, wherein the vehicle dynamically adjusts the conservation stage based on updated SOC or predicted energy consumption.

12. A method for mission-based vehicle range extension, comprising: determining a destination and a remaining distance to the destination; acquiring a state of charge (SOC) of a vehicle energy storage device and determining a projected SOC at the destination; evaluating whether a mission criterion is satisfied, the mission criterion comprising whether the projected SOC is sufficient to complete the mission to the destination; and initiating a plurality of energy conservation stages, each stage imposing a progressively greater restriction on vehicle performance as the projected SOC decreases or fails to meet the mission criterion.

13. The method of claim 12, wherein the energy conservation stages include limiting vehicle speed and disabling non-essential vehicle systems.

14. The method of claim 12, further comprising calculating energy consumption along a planned route using route grade, traffic, and weather inputs.

15. The method of claim 12, wherein the projected SOC is calculated using a forward-looking energy consumption model.

16. The method of claim 12, wherein the vehicle continues the multistage conservation sequence until the destination is reached or the SOC falls below a critical level.

17. The method of claim 12, wherein the mission criterion accounts for user-defined preferences including a target arrival SOC or charging location en route.

18. The method of claim 12, wherein each stage is associated with a SOC band and distance-to-destination threshold.

19. The method of claim 12, wherein the vehicle provides visual or auditory alerts when transitioning between conservation stages.

20. The method of claim 12, wherein the conservation stages include predefined system-level profiles stored in a lookup table indexed by SOC and route data.
